(19) United States
(12) Patent Application Publication
(10) Pub. No.: US 2010/0054578 A1
(43) Pub. Date: Mar. 4, 2010

(54) Method and apparatus for interactive visualization and distribution of very large image data sets

(76) Inventor: Frank Edughom Ekpar, Aizuwakamatsu City (JP)

Correspondence Address: Frank Edughom Ekpar, Matsunaga 1-17-26-A107, Ikki-Machi, Aizuwakamatsu City, Fukushima, 965-0001, JP

(21) Appl. No.: 12/229,588

(22) Filed: Aug. 26, 2008

(51) Int. Cl. G06K 9/00

(52) U.S. Cl. 382/154

(57) ABSTRACT

The present invention discloses a system for real-time visualization and distribution of very large image data sets using on-demand loading and dynamic view prediction. A robust image representation scheme is used for efficient adaptive rendering and a perspective view generation module is used to extend the applicability of the system to panoramic images. The effectiveness of the system is demonstrated by applying it both to imagery that does not require perspective correction and to very large panoramic data sets requiring perspective view generation. The system permits smooth, real-time interactive navigation of very large panoramic and non-panoramic image data sets on average personal computers without the use of specialized hardware.

### CROSS-REFERENCE TO RELATED APPLICATIONS

This U.S. Non-Provisional Application claims the benefit of U.S. Provisional Application Ser. No. 60/965,715, file on Aug. 23, 2007, herein incorporated by reference.

### BACKGROUND OF THE INVENTION

1. Field of the Invention

The present invention relates generally to the fields of distribution and visualization of image data sets. In particular, the invention relates to a system for the interactive distribution and visualization of very large image data sets.

2. Description of the Prior Art

As a consequence of the decreasing cost and increasing capabilities of modern digital image capture, storage, manipulation and visualization hardware and software, the scope of applications of very large image data sets has expanded substantially in recent times. The creation, manipulation and rendering of medical image data sets has traditionally required specialized and relatively expensive computer systems due to the large size and complexity of the data. Demands for interactive visualization and data transmission over networks have further exacerbated the problem. Thomas A. Funkhouser and Carlo H. S'equin in the paper entitled “Adaptive Display Algorithm for Interactive Frame Rates During Visualization of Complex Virtual Environments”, Proceedings SIGGRAPH, 1993, pp. 247-254, describe an adaptive display algorithm for interactive frame rates during visualization of very complex virtual environments that relies upon a hierarchical model representation in which objects are described at multiple levels of detail and can be drawn with various rendering algorithms. Funkhouser et al adjust image quality adaptively to maintain a uniform, user-specified target frame rate. This solution often permits real-time visualization at the expense of image quality, especially when data is transmitted over bandwidth-limited networks. Ron Kikinis et al. in the paper entitled “A digital brain atlas for surgical planning, model driven segmentation and teaching”, IEEE Transactions on Visualization and Computer Graphics, Volume 2, Issue 3, 1996, pp. 232-241, developed a digital brain atlas for surgical planning, model driven segmentation and teaching comprising a three-dimensional (3D) digitized atlas of the human brain to visualize spatially complex structures that was designed for use with magnetic resonance (MR) imaging data sets. Reliance on expensive computer systems, hardware rendering and the use of pre-rendered views on inexpensive computer systems limited the applicability of this solution. The brain atlas was later extended with a multi-layer image representation and compression scheme designed to allow average users to interact with high-quality 3D scenes derived from large data sets typically found in medical applications. This extension did not directly support real-time navigation or multi-resolution zoom capabilities but allowed other types of interactivity such as turning structures on and off, and adjusting their transparency and color. Solutions to the problems of rendering and effects in large-scale image data sets have been described in the articles entitled “Hierarchical splatting: A progressive refinement algorithm for volume rendering”, ACM SIGGRAPH Computer Graphics Proceedings, 25(4), 1991, pp. 285-288, by D. Laur et al, “Efficient ray tracing of volume data”, ACM Transactions on Graphics, 9(3), 1990, pp. 245-261, by Marc Levo, and “Transparency and antialiasing algorithms implemented with the virtual pixel maps technique”, IEEE Computer Graphics and Applications, 9(4), 1989, pp. 43-55, by Abraham Mammen.

As explained by R. Benosman in the paper entitled “Panoramic imaging from 1767 to the present”, Proc. International Conference on Advanced Robotics, Workshop, Volume 1, 2001, pp. 9-10, the use of panoramic imaging techniques dates back as far as the 18^{th} century, when early works of art featuring panoramic projections were created. A wide variety of techniques for creating, storing, transmitting and visualizing panoramic images have been reported in the scientific literature. One key challenge for a panoramic imaging system is the encoding of enough visual information to make the system practical and cost-effective. The use of rotating cameras to build panoramic mosaics, as described in “Video mosaics for virtual environments”, Computer Graphics and Applications, 16(3), 1996, pp. 23-30 by R. Szeliski and in “Robust video mosaicing through topology inference and local to global alignment”, Proc. Fifth European Conference on Computer Vision, Volume 2, 1998, pp. 103-119 by H. Sawhney et al., while facilitating the capture of panoramas of static scenes, is of limited practical value in more dynamic scenes. P. Gregus, in the article entitled “PAL-optic based instruments for space research and robotics”, Laser and Optoelektronik, Volume 28, 1996. pp. 43-49, introduced a compact omnidirectional image capture system comprising both reflective and refractive elements (catadioptric) and that is capable of capturing a complete 360-degree field of view in a single image frame with no moving parts in the article entitled. Since they generally have no moving parts and can generate a panoramic view in a single image frame, catadioptric systems can be used to capture both static and dynamic scenes and video in real-time. Aspects of the geometrical characteristics of catadioptric systems were described by Geyer et al. in “Catadioptric projective geometry”, Proc. International Conference on Advanced Robotics, Volume 1, 2001, pp. 17-30. Yagi et al. writing in “Real-time omni directional image sensor (copis) for vision-guided navigation”, IEEE Transactions on Robotics and Automation, 10 (1), 1994, pp. 11-22 and Chahl et al. writing in “Reflective surfaces for panoramic imaging”, Applied Optics, Volume 36, 1997, pp. 8275-8285 proposed other panoramic image capture systems that are amenable to real-time operation. The popular Apple QuickTime Virtual Reality Authoring System described by Shenchang Eric Chen in “QuickTime VR: an image-based approach to virtual environment navigation”, Computer Graphics (Proc. SIGGRAPH), 1995, pp. 29-38 allows the generation of cylindrical panoramic images from several overlapping still image segments captured using a conventional camera and provides rendering and multimedia integration features. Robust methods for navigating panoramic images and for correcting distortions in panoramic images have been introduced by Frank Ekpar et al. in “Constructing arbitrary perspective-corrected views from panoramic images using neural networks”, Proc. 7th International Conference on Neural Information Processing, Volume 1, 2000, pp. 156-160, “Correcting distortions in panoramic images using constructive neural networks”, International Journal of Neural Systems, Volume 13 (4), 2003, pp. 239-250 and U.S. Pat. No. 6,671,400.

Existing methods for the distribution and visualization of panoramic images on average personal computers generally apply to relatively small and medium scale images. For example, U.S. Pat. No. 6,466,254 describes a method that utilizes image tiles and the current view to facilitate electronic distribution and visualization of panoramic images. Since the method of the '254 patent relies on the view parameters to determine what portion of the original panorama to distribute, latencies are inevitable especially on bandwidth-limited networks such as the Internet. The present invention teaches the use of a dynamic prediction scheme that allows views to be predicted for any desired number of time steps in the past or future. Consequently, latencies can be eliminated since the portions of the original image that would be required in future time steps could be pre-fetched, pre-loaded or synthesized as appropriate. Additionally, past views that were skipped due to bandwidth limitations or any other reasons could easily be reconstructed from the dynamically predicted view data. The techniques taught by the present invention allow for the distribution and visualization of very large (in the order of several giga-pixels, tera-pixels or more per image frame) panoramic and non-panoramic images at real-time frame rates (about 30 frames per second) on average personal computers and on bandwidth-limited networks without the use of specialized hardware. The system of the present invention uses a robust image representation scheme for efficient adaptive rendering and dynamic view prediction to overcome the latencies present in the prior art and to allow for more flexible and efficient operation.

On May 1, 2007, the inventor submitted an article describing aspects of the present invention for peer review and said article has been accepted for publication in the proceedings of the 7^{th} Institute of Electrical and Electronics Engineers (IEEE) Conference on Computer and Information Technology scheduled for Oct. 16 to 19, 2007. NOTE: Said article entitled “On the Interactive Visualization of Very Large Image Data Sets” was published in the Proceedings of the 7^{th} IEEE International Conference on Computer and Information Technology, pages 627-632.

### SUMMARY OF THE INVENTION

It is an object of the present invention to overcome the limitations of the prior art set forth above by providing a system for the distribution and visualization of very large image data sets.

### BRIEF DESCRIPTION OF THE DRAWINGS

FIG. 1 illustrates the tier-1 image representation used by the preferred embodiment of the present invention.

FIG. 2 illustrates the partitioning or segmentation of the original image frame to for tier-2 of the image representation used by the preferred embodiment of the present invention.

FIG. 3 is a conceptual illustration of the projection or re-projection of a panoramic image onto the surface of a sphere.

### DETAILED DESCRIPTION OF THE PREFERRED EMBODIMENTS

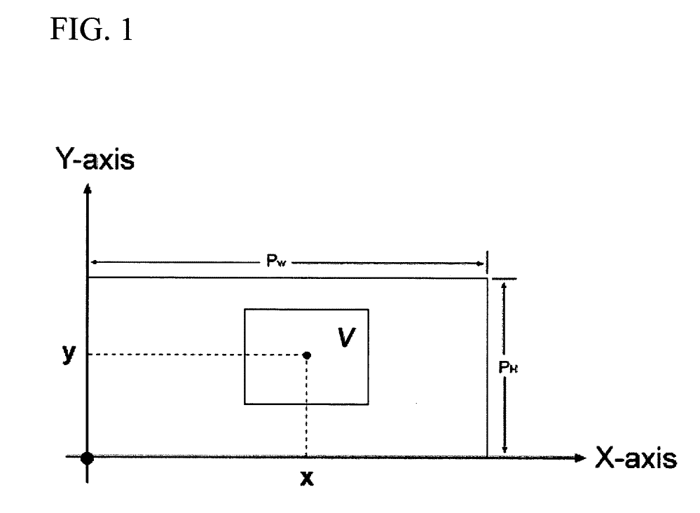

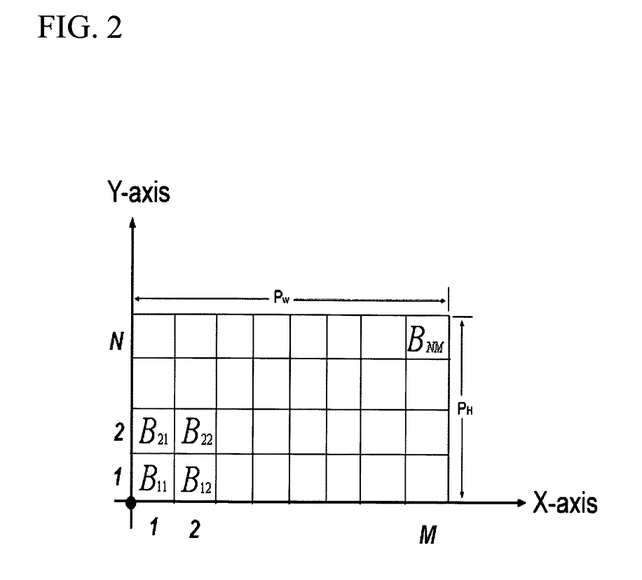

Based on the observation that interactive rendering of the image data set involves the display of a relatively small (compared to the size of the underlying image data itself) view window, the preferred embodiment of the present invention teaches the use of a robust two-tier or bi-level representation of the image. The first level contains a virtual view of an entire image frame as a single continuous set of pixels. FIG. 1 illustrates the first level for a two-dimensional image frame of width p_{w} and height P_{H} pixels. The region of interest or view window is indicated as V in FIG. 1. Since a single image frame can be very large, it is generally impractical to attempt to load the entire image frame (typically corresponding to tens of gigabytes of physical memory) into memory at once. Consequently, the second level comprises a segmentation or partitioning of each image frame into distinct image blocks of a size and color depth that facilitates straightforward manipulation on an average personal computer. This partitioning scheme is shown in FIG. 2, where the image of FIG. 1 has been segmented into N×M distinct image blocks labeled B₁₁, B₁₂, . . . , B_{NM}. The size of each partition can be chosen such that the view window, V, straddles just a couple of image blocks. In this case only those image blocks in the second layer that are covered or straddled by the view window need be loaded into memory for the manipulation or rendering of the view, leading to a significantly reduced memory footprint.

The use of a two-tier image representation scheme permits alternate views of the image data that make further manipulation easier. For example, the simplicity of the first level permits the applications of a multi-resolution pyramid representation of the image data, such as that described by Peter J. Burt et al. in “The Laplacian Pyramid as a Compact Image Code”, IEEE Transactions on Communications, 1983, pp. 532-540, for efficient compression, storage and transmission and optionally for adaptive rendering that maintains a constant frame rate. A thumbnail of the entire image could also be generated at the first level. Such a thumbnail could be used to display a lower resolution version of the view window while waiting for image data to be retrieved and/or decompressed. Furthermore, the dynamic view prediction and on-demand loading algorithms described hereinafter are readily applicable to the second tier's image block representation.

Following is an outline of the process of visualizing the data sets according to the preferred embodiment. First, a view window V is specified as illustrated in FIG. 1. The view window represents the segment of the current image frame that is indicated by the view parameters. In the current implementation, three view parameters are used to control the view. These are the pan angle (θ), the tilt angle or azimuth (φ) and the zoom or scale factor. User input is received via the keyboard and/or mouse clicks within the view window. Alternatively, a head-mounted display and orientation sensing mechanism could also be used. Views are generated based on view window size and received input. In order to facilitate interactive rendering without the latencies and other limitations associated with the prior art, the rate of change of each of the view parameters with respect to time is computed dynamically. The computed rate of change is then used to predict the value of the parameter at any desired time in the past or future. Equation 1 illustrates the use of the dynamic view prediction algorithm for a specific view parameter P—pan, tilt or zoom level.

p=p₀+KaT (1)

In Equation 1, P is the predicted value of the parameter at time T, p₀ is the current value of the parameter, α is the dynamically computed rate of change of the parameter with respect to time and K is a scale factor, usually 1. The values of the parameters predicted by Equation 1 are used to determine which specific image blocks need to be loaded into memory at any given time. A computer software implementation using a background thread dedicated to loading those image blocks that are covered by the current view as well as any additional image blocks that might be needed for rendering the view in the future or past, that is, a number of future or past time steps, could be used. Since the number of image blocks per frame is usually small, it is practical to preload, pre-fetch or pre-synthesize as appropriate, image blocks that would be required for rendering several time steps ahead or behind—permitting smooth rendering at real-time rates. The image data could be distributed from a server over the Internet or other network or accessed from local storage on a host computer. Any other alternative source and method of distribution could be used where appropriate.

Studies with image visualization systems have consistently shown that the use of a damping or inertial function to facilitate gradual changes in view parameters leads to the perception by users of a vastly smoother, more natural and more intuitive viewing process. This observation can be exploited by the dynamic view prediction algorithm of the present invention to provide smooth, interactive distribution and visualization of very large image data sets even over relatively slow network connections such as the current Internet and other bandwidth-limited scenarios without the latencies and other deficiencies associated with the prior art. The gradually changing view parameters would then permit many more future or past time steps to be computed, preloaded, pre-fetched and/or pre-synthesized as appropriate to a greater degree of accuracy.

Now the application of the techniques described herein to large non-panoramic data sets is described. Consider the image shown in FIG. 1. For the sake of simplicity and to facilitate uniformity with panoramic image data sets, pixel positions on the image are represented as angular displacements. Each position along the horizontal axis is represented by a corresponding angle θ between 0 and 2π radians while each position along the vertical axis is represented by a corresponding angle φ between −π/2 and π/2 radians. Using this representation, Equations 2 and 3 depict how the required angular coordinates θ and φ can be obtained for the point with coordinates x and y in FIG. 1.

$$\begin{matrix}θ = \frac{2 π x}{{P}_{W}} & ( 2 ) \\ ϕ = \frac{π y}{{P}_{H}} - \frac{π}{2} & ( 3 )\end{matrix}$$

Although in principle it is possible to capture very large images of the type described here in a single image frame using a single imaging device, it is often more practical to capture a series of overlapping high-resolution segments of the image and then stitch these together to form a single image mosaic. Techniques for stitching overlapping image segments are well known. One significant problem with image stitching is how to make the seams between overlapping segments invisible. A wide variety of image blending techniques exist. Generally, the choice of a specific image blending technique depends on the requirements of the specific application. The multi-resolution spline technique proposed by Peter J. Burt et al. in “A Multiresolution Spline with Application to Image Mosaics”, ACM Transactions on Graphics, Volume 2, Number 4, 1983, pp. 217-236, gives satisfactory results albeit requiring large amounts of memory. Peter J. Burt et al. first decompose the images to be splined into a set of band-pass filtered component images with the component images in each frequency band assembled into a corresponding band-pass mosaic. Component images are joined using a weighted average within a transition zone proportional in size to the wavelengths that comprise the band. Ultimately, summation of the band-pass mosaic images is used to derive the output mosaic image.

Image navigation for non-panoramic data sets comprises the display of the selected portion of the image data set. User input could be obtained using standard input devices such as the mouse, keyboard and joystick. Simple image transformations such as zooming, rotation could be applied to the views.

Panoramic images can be acquired using a wide variety of techniques. One of the simplest methods of acquiring panoramic images involves the capture of a series of overlapping image segments around a unique effective viewpoint using a conventional digital camera. The overlapping segments are then stitched together and blended (using the multi-resolution spline technique of Peter J. Burt et al. or any other appropriate technique) to produce the complete panoramic mosaic.

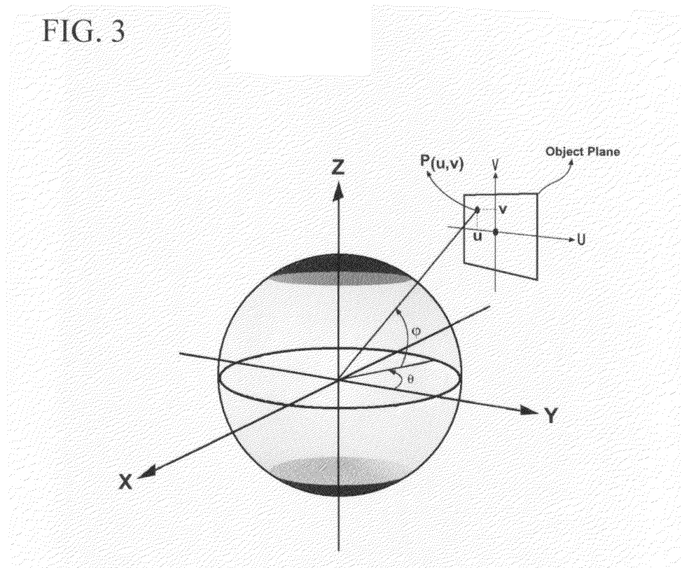

Panoramic images are first re-projected onto a spherical surface. This allows the application of a uniform perspective correction algorithm during the navigation of the image. It is convenient to realize the spherical representation in the first tier of the image data set representation proposed herein. FIG. 3 is a conceptual illustration of the projection or re-projection of a panoramic image onto the surface of a sphere. Portions of the sphere for which panoramic image data is not available (for example, when the panorama is acquired using a system with a vertical field of view that is less than π radians) can be replaced with user-supplied data or simply filled with a uniform color. The region of interest or view window (corresponding to V in FIG. 1) is depicted on the U-V coordinate plane as a perspective projection of the region of the panorama indicated by the viewing parameters where the point with angular coordinates θ and φ on the surface of the sphere is projected onto the point with planar coordinates P(u,v) on the U-V coordinate plane.

More generally, the present invention teaches a method of navigating very large data sets including, but not limited to image data sets, by presenting a user-selected region of interest and permitting real-time operation by dynamically predicting and making available subsets of the original data set. Equations 4, 5, 6 and 7 summarize aspects of the principles of operation of the present invention.

R^{K}=f(X^{N}) (4)

X^{N}={x₁,x₂, . . . , x_{N}} (5)

{T,θ,φ,λ}⊂X^{N} (6)

{B₁₁, . . . , B_{NM}}⊂R^{K} (7)

In Equation 4, R^{K} denotes the region of interest within the original data set characterized by a set of k features. The features could be a set of pixels in a 2D or 3D still or time-varying image, a set of image blocks (possibly at a given level of a resolution-based hierarchical pyramid) within a 2D or 3D still or time-varying image, or any other suitable feature set within an appropriate data set. X^{N} is a set of N parameters (decomposed into the component parameters {x₁,x₂, . . . ,x_{N}} in Equation 5) that determine the characteristics of the region of interest. As indicated in Equation 4, the region of interest is a function of the parameter set X^{N}. The foregoing description of the preferred embodiment of the present invention illustrates the prediction of a region of interest—indicated generally as the set of image partitions {B₁₁, . . . , B_{NM}} which in turn is a subset of the region of interest space R^{k} as shown in Equation 7—on the basis of time-dependent changes in viewing parameters representing pan, tilt and zoom level. Equation 6 encodes the parameter space (T depicts time, θ represents pan, φ represents tilt while λ represents zoom level—as a subset of the total parameter set X^{N}) in the preferred embodiment.

It should be understood that numerous alternative embodiments and equivalents of the invention described herein may be employed in practicing the invention and that such alternative embodiments and equivalents fall within the scope of the present invention.

What is claimed is:

1. A method of navigating data sets comprising steps of defining a region of interest within the data set, acquiring, processing and presenting a subset of the data set corresponding to said region of interest, dynamically predicting the subset of said data set that would correspond to said region of interest a number of time steps from the current presentation time and acquiring, processing and providing access to said predicted subsets to facilitate smooth and efficient navigation of said data set.

2. The method of claim 1 wherein said data set comprises very large still or time-varying 2D or 3D image data.

3. The method of claim 1 wherein said dynamically predicted subset of said data set comprises partitions of said data set representing said region of interest.

4. The method of claim 1 wherein said dynamically predicted subset of said data set comprises representations of partitions contained in a hierarchical pyramid of one or more layers of resolution-varying subsets of said data set representing said region of interest.

5. An apparatus implementing means of navigating data sets by defining a region of interest within the data set, acquiring, processing and presenting a subset of the data set corresponding to said region of interest, dynamically predicting the subset of said data set that would correspond to said region of interest a number of time steps from the current presentation time and acquiring, processing and providing access to said predicted subsets to facilitate smooth and efficient navigation of said data set.

6. The apparatus of claim 5 wherein said data set comprises very large still or time-varying 2D or 3D image data.

7. The apparatus of claim 5 wherein said dynamically predicted subset of said data set comprises partitions of said data set representing said region of interest.

8. The apparatus of claim 5 wherein said dynamically predicted subset of said data set comprises representations of partitions contained in a hierarchical pyramid of one or more layers of resolution-varying subsets of said data set representing said region of interest.
